(19) United States
(12) Patent Application Publication
(10) Pub. No.: US 2015/0345700 A1
(43) Pub. Date: Dec. 3, 2015

(54) HOLDING ACCESSORY TO ASSIST WITH MANIPULATING A PORTABLE ELECTRONIC DEVICE OF THE TOUCH-SCREEN TABLET TYPE

(71) Applicant: Paul-Henri ROBERT, Boulogne (FR)

(72) Inventor: Paul-Henri Robert, Boulogne (FR)

(21) Appl. No.: 14/435,032

(22) PCT Filed: Oct. 10, 2013
(86) PCT No.: PCT/EP2013/071118

§ 371 Date: Aug. 10, 2015

(30) Foreign Application Priority Data
Oct. 10, 2012 (FR) 1259663

(51) Int. Cl. F16M 13/06; A45F 5/10; G06F 3/041

(52) U.S. Cl. CPC F16M 13/06; G06F 3/0416; A45F 5/10

(57) ABSTRACT

This holding accessory to assist with manipulating a portable electronic device of the touch-screen tablet type comprises a holding element (3), mounted in a manner such that it can be deployed with respect to the device, between a folded position and a deployed active position. It comprises a support (2) on which the holding element is mounted, said support comprising means (5) for removably attaching the support to the housing of the device.

The invention involves accessories for portable electronic devices of the touch screen tablet type, but it pertains generally to any other type of portable electronic device, such as a portable telephone, geolocation device, digital music player, personal digital assistant, game console, etc.

As is known, this type of device, especially the touch screen tablets, comprise a housing inside which all of the device electronics is accommodated and a display screen on the front side.

In touch screen tablets, the display screen occupies the major portion of the front surface of the device.

The device makers offer accessories to supplement the device as sold. Many types of accessories have been proposed, especially to protect the device against impact or scratching or to hold it in an upright position during use.

As for maintaining the device in the upright position during use, when the screen can be easily manipulated by the user, the device makers offer slipcover or hood systems which, when the screen is exposed, can be configured so as to form a support surface or prop against which the tablet can rest.

One finds that certain devices offered by the device makers often come with a shell or a slipcover of complementary shape to that of the tablet and in which the tablet is lodged. The shell or slipcover is generally meant to remain constantly on the tablet.

The purpose of the invention is to propose an accessory to assist with manipulating of a portable electronic device, which can be fixed to or detached from the device as needed.

Thus, its subject matter is a holding accessory to assist with manipulating a portable electronic device of the touch screen tablet type, comprising a holding element mounted in a manner such that it can be deployed with respect to the device between a folded position and a deployed active position.

This accessory comprises a support on which the holding element is mounted, said support comprising means for removably attaching the support to the housing of the device.

According to another characteristic of the invention, the means of removable attachment comprise a suction cup.

The means of removable attachment can furthermore be mounted in rotational manner on the support.

According to yet another characteristic of the invention, the holding element is mounted in articulated manner about an axis parallel to a general plane of the support.

In one embodiment, the support comprises an impression to receive the holding element in the folded position.

For example, the holding element is a prop able to support the device in a tilted position of use.

It can also be comprised of a gripping handle.

Other purposes, characteristics and advantages of the invention will appear from a reading of the following description, given solely as an example without limitation, and making reference to the enclosed drawings, in which:

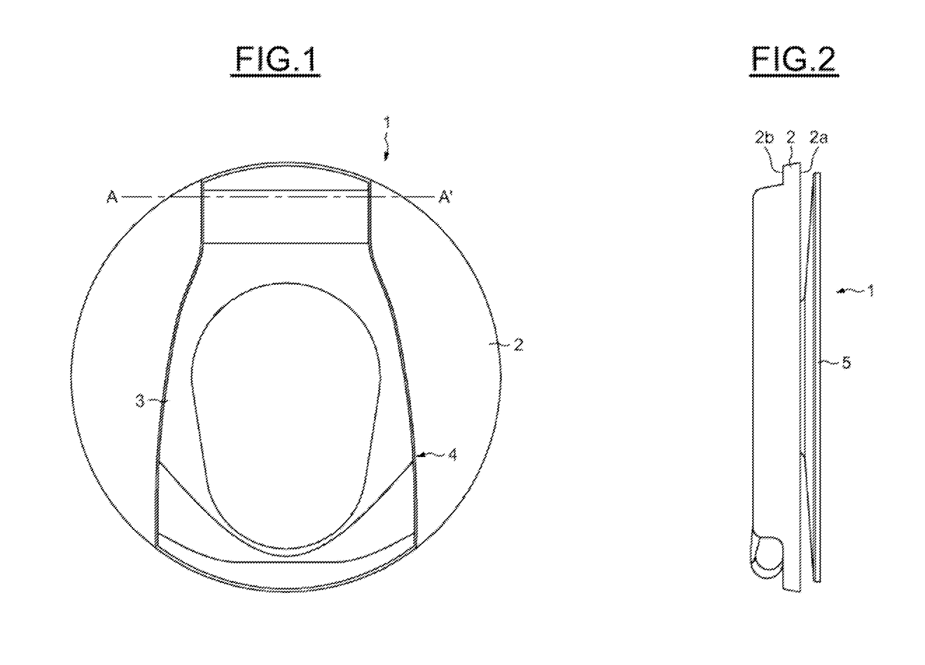

FIGS. 1 and 2 are respectively rear and profile views of an accessory according to the invention;

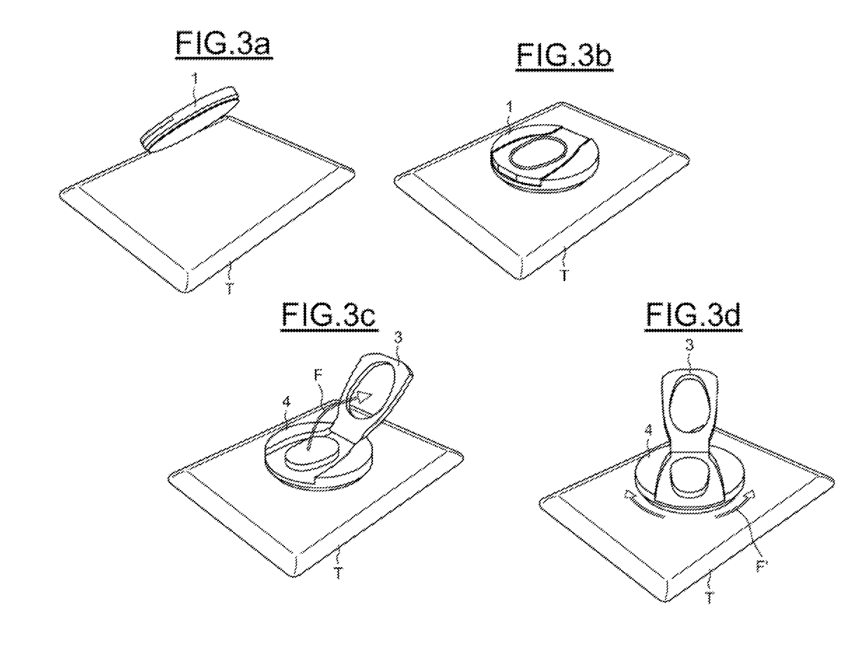

FIGS. 3a, 3b, 3c and 3d illustrate the mounting of the accessory of FIGS. 1 and 2 on a touch screen tablet; and

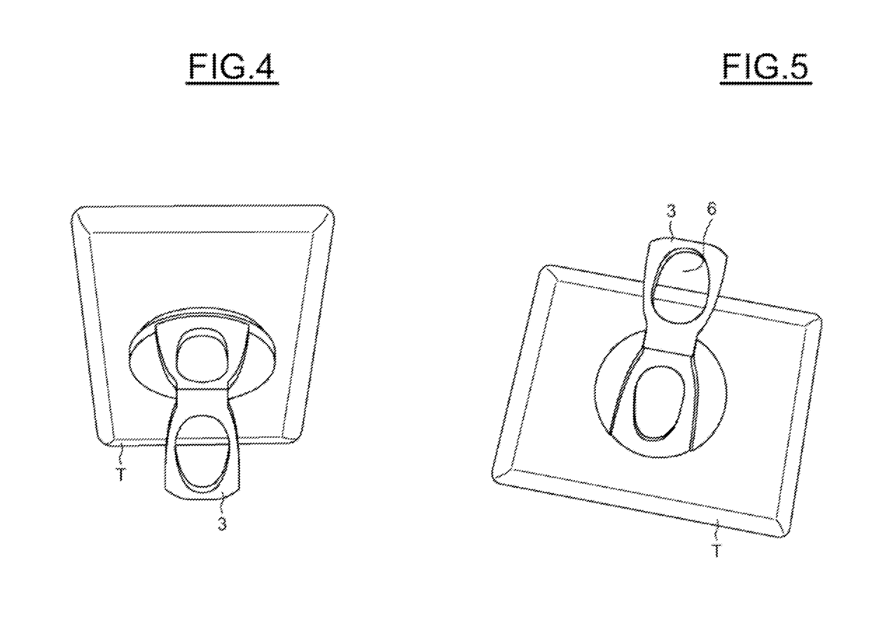

FIGS. 4 and 5 show examples of the use of the accessory of FIGS. 1 and 2.

In FIGS. 1 and 2 there is shown a holding accessory of a touch screen tablet according to the invention, designated by the general reference number 1.

In the sample embodiment illustrated in these figures, the accessory 1 is intended to be attached to the body of a portable electronic device of touch screen type, such as the touch screen tablet marketed in particular but not exclusively by the Apple corporation under the brand iPad®.

As one can see, the accessory 1 has a support 2 on which a holding element 3 is mounted.

More particularly, the support 2, which is made of plastic for example, is circular overall and comprises a first surface 2a, which is intended to be turned toward the body of the tablet, and an opposite surface 2b on which the holding element 3 is attached.

The holding element 3 is comprised here of a prop on which the tablet is supposed to rest in a tilted position of use.

The prop 3 is mounted in articulated manner about an axis A,A′ arranged in the vicinity of the periphery of the support 2 and extending in parallel with the general plane of the support, so that it can take up a retracted position in which the prop 3 is folded against the support 2 and an active deployed position (FIGS. 3c and 3d). The support 2 has an impression 4 for this purpose, formed so as to constitute a lodgment in which the prop 3 is lodged in the folded position.

It will be noted that the folding angle of the prop 3 is around 180° so that in the deployed position it can extend essentially flat against the body of the tablet.

Now, one notes in FIGS. 1 and 2 that the accessory 1 comes with means of removable attachment 5 able to provide for its attachment to the body of the device.

These holding means are constituted here by a sucker cup, made of plastic, suitable for the intended use. It comprises an apron 6 by which it is mounted on the support 2.

It will be noted in this regard that the sucker cup 5 is attached to the support 2 in rotational manner in a range of 360°. The axis of rotation extends perpendicular to the general plane of the support 2.

The accessory 1 just described thus has a particularly simple structure.

Considering now FIGS. 3a to 3d, in order to use such an accessory one need simply apply it against the rear body of the tablet T and exert pressure against the support to attach the sucker cup 5 to the body.

In a position of rest, the prop 3 is folded in its lodgment 4 (FIG. 3b).

One now simply needs to deploy the prop 4 along arrow F (FIG. 3c) and orient it however one needs to do (arrow F′).

In the deployed position, the prop 4 allows the user to position the tablet T in a tilted position of use. It will be noted that, thanks to the rotational mount of the suction cup 5 on the support 2, the tablet can be used either in “portrait” position or in “landscape” position.

The opening angle of the prop 4 can be chosen so as to adjust the inclination of the tablet.

It will be noted in this regard that one will mount the prop 3 on the support to achieve sufficient friction to prevent any abrupt closing of the prop.

Finally, making reference to FIG. 5, it will be noted that the prop 3 advantageously comes with a central opening 6. Thus, when the prop 3 is fully deployed, this constitutes a handle for transporting the tablet T.

Of course, when the accessory is no longer in use, it can be detached from the tablet by simply pulling on the support.

1. Holding accessory to assist with manipulating a portable electronic device of the touch screen tablet type, comprising a holding element (3) mounted in a manner such that it can be deployed with respect to the device between a folded position and a deployed active position, characterized in that it comprises a support (2) on which the holding element is mounted, said support comprising means (5) for removably attaching the support to the housing of the device.

2. Accessory according to claim 1, characterized in that the means of removable attachment comprise a suction cup (5).

3. Accessory according to claim 1, characterized in that the means of removable attachment are mounted in rotational manner on the support (2).

4. Accessory according to claim 1, characterized in that the holding element is mounted in articulated manner about an axis (A,A′) parallel to a general plane of the support.

5. Accessory according to claim 1, characterized in that the support comprises an impression (4) to receive the holding element in the folded position.

6. Accessory according to claim 1, characterized in that the holding element is a prop able to support the device (T) in a tilted position of use.

7. Accessory according to claim 1, characterized in that the holding element is a gripping handle.
